(19) United States
(12) Patent Application Publication
(10) Pub. No.: US 2010/0051548 A1
(43) Pub. Date: Mar. 4, 2010

(54) System and Method for Solvent Extraction

(76) Inventors: Jerome P. Dorlac, Tucson, AZ (US); Hans Heln, El Noviclado (CL)

Correspondence Address: MCANDREWS HELD & MALLOY, LTD, 500 WEST MADISON STREET, SUITE 3400, CHICAGO, IL, 60661, US

(21) Appl. No.: 12/204,548

(22) Filed: Sep. 4, 2008

(51) Int. Cl. B01D 11/04

(52) U.S. Cl. 210/638; 210/200; 210/202

(57) ABSTRACT

A settling system for use in solvent extraction separation of a first phase from a second phase after mixing, the second phase having a greater chemical affinity for a component dissolved or dispersed in the first phase for extracting the component from the first phase. The settling system includes a pre-settler of a plurality of channels arranged for flow of the first and second phases generally counter-currently with respect to each other for initial separation of the first and second phases. The settling system also includes a main settler for further separating the first and second phases.

### TECHNICAL FIELD

The present application relates to a method of solvent extraction and a system for use in carrying out the method.

### BACKGROUND DISCUSSION

Solvent extraction is used inter alia for removing selected metals from aqueous solution. The process typically comprises the extraction of the metal values from aqueous solution by an organic extractant, stripping of the metal values from the metal loaded organic extractant using an aqueous stripping solution, and, optionally, a wash stage. In the extraction, stripping and wash stages, each stage consists of a mixer (or series of mixers) and a settler, where metal exchange from one phase to the other takes place. The number of extraction, strip and wash stages required to recover a desired metal value can be determined by metallurgical testing of the solutions in question. The mixer-settler of each stage consists of a mixer (or mixers) section and a settler section. In the mixer section, the aqueous solution containing the metal value is mixed with an organic extractant that selectively combines with the metal to be extracted. During the extraction stage the aqueous solution and organic are mixed to form an emulsion to provide the greatest amount of contact between the organic and aqueous phases to maximize extraction of the metal into the organic phase. In a stripping mixing stage, the metal value is re-extracted from the organic phase by the aqueous stripping solution. When an emulsion from either the extraction or strip stage enters the respective settler section, the emulsion from the mixer is introduced into the settler where the organic and aqueous phases are allowed to separate with the organic forming a layer above the aqueous phase. The two phases are in constant flow in the settler. Separate overflows for the organic and aqueous phases are provided at one end of the settler so that the organic is retrieved for subsequent treatment in the next stage of extraction or stripping. The exiting aqueous solution also reports to the respective subsequent destination in the process. Typically, both the organic and the aqueous phases flow in the same direction in the settler, i.e. there is co-current flow in the settler.

A problem with the above conventional arrangement is that stable emulsions originating and promoted by the presence of suspended solids in the aqueous solution, referred to as “crud”, form a layer between the organic and aqueous layers in the settler and a so-called “crud-run” is experienced when the crud accumulates at the organic overflow and exits with the organic, which causes problems.

U.S. Pat. No. 6,099,732, filed Apr. 19, 1999, to Dorlac discloses a solvent extraction method and apparatus in which the organic and aqueous phases flow counter-currently (in opposite directions) in the settler, rather than co-currently. The entire contents of U.S. Pat. No. 6,099,732 are incorporated herein by reference. This counter-current flow was found to result in much of the crud being maintained at the interface between the organic and aqueous phases, with a significant reduction in crud in the overflow of the organic phase. Throughput in such apparatus is dictated inter alia by phase separation and metal recovery.

Further improvements in solvent extraction are driven by industry demands for increased recovery of metal values, increased throughput and reduced capital investment as well as operating cost.

### SUMMARY

It is an object of the present invention to obviate or mitigate at least one disadvantage of previous solvent extraction methods and apparatus.

According to one aspect, there is provided a method of solvent extraction for extracting a component dissolved or dispersed in a first phase, into a second phase. The method includes mixing the first phase with the second phase, the second phase being insoluble or immiscible with the first phase and having a greater chemical affinity for the component for extracting the component from the first phase. The method also includes subjecting the mixed first and second phases to settling for separating the first and second phases, the settling including a pre-settling stage in which there is an initial separation of the first and second phases, and a subsequent main settling stage for further separating the first and second phases. The pre-settling stage includes a plurality of channels in which the first and second phases are caused to flow generally counter-currently with respect to each other.

According to another aspect, there is provided a settling system for use in solvent extraction separation of a first phase from a second phase after mixing, the second phase having a greater chemical affinity for a component dissolved or dispersed in the first phase for extracting the component from the first phase. The settling system includes a pre-settler of a plurality of channels arranged for flow of the first and second phases counter-currently with respect to each other for initial separation of the first and second phases. The settling system also includes a main settler for further separating the first and second phases.

According to still another aspect, there is provided a settling system for use in separating a first phase from a second phase after mixing in a solvent extraction process, the second phase having a greater chemical affinity for a component for extracting the component from the first phase. The system includes a settling tank having a respective outlet at each end thereof for promoting counter-current flow of the first and second phases with respect to each other. The settling tank has at least one baffle arranged at an angle offset from the vertical for promoting separation of the first phase from the second phase.

Other aspects and features of the present invention will become apparent to those ordinarily skilled in the art upon review of the following description of specific in conjunction with the accompanying figures.

### BRIEF DESCRIPTION OF THE DRAWINGS

Embodiments of the present application will now be described, by way of example only, with reference to the attached Figures, wherein:

FIG. 1 is a perspective view of a settling system for use in solvent extraction according to one embodiment;

FIG. 2 is a top plan view of the settling system of FIG. 1;

FIG. 3 is a perspective view of a portion of the settling system of FIG. 1, drawn to a larger scale;

FIG. 4 is a section taken along the line 4-4 of FIG. 2;

FIG. 5 is a sectional side view of an inclined baffle of the settling system of FIG. 1;

FIG. 6 is a side view of a portion of a main settler of the settling system of FIG. 1 during use; and

FIG. 7 is a sectional side view of a portion of a channel of the settling system, including an alternative baffle arrangement.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Reference is made to the Figures to describe a settling system for use in solvent extraction separation of a first phase from a second phase after mixing. The settling system is indicated generally by the numeral 20. The second phase has a greater chemical affinity for a component dissolved or dispersed in the first phase for extracting the component from the first phase. The settling system 20 includes a pre-settler 22 of a plurality of channels arranged for flow of the first and second phases counter-currently with respect to each other for initial separation of the first and second phases. The settling system 20 also includes a main settler 24 for further separating the first and second phases.

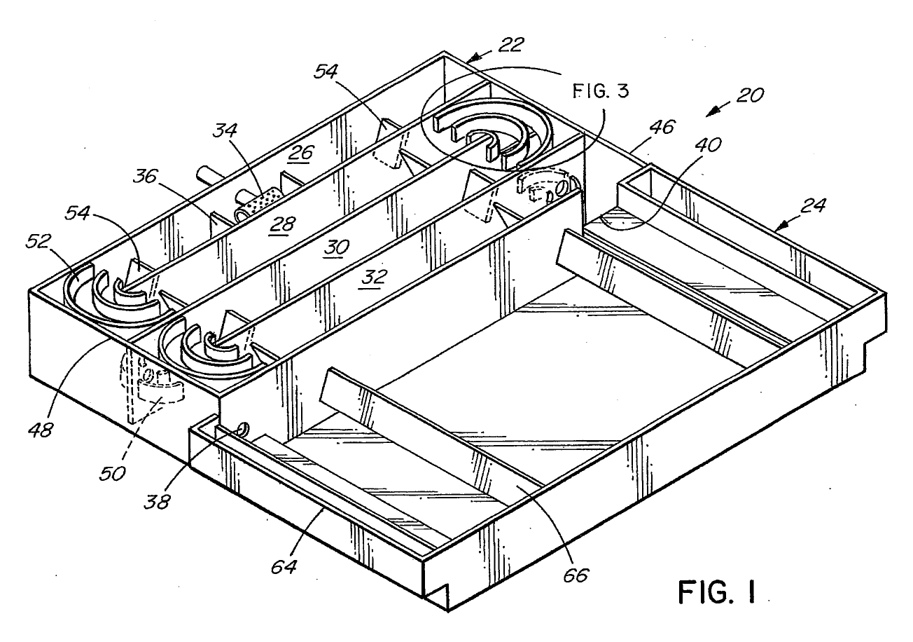

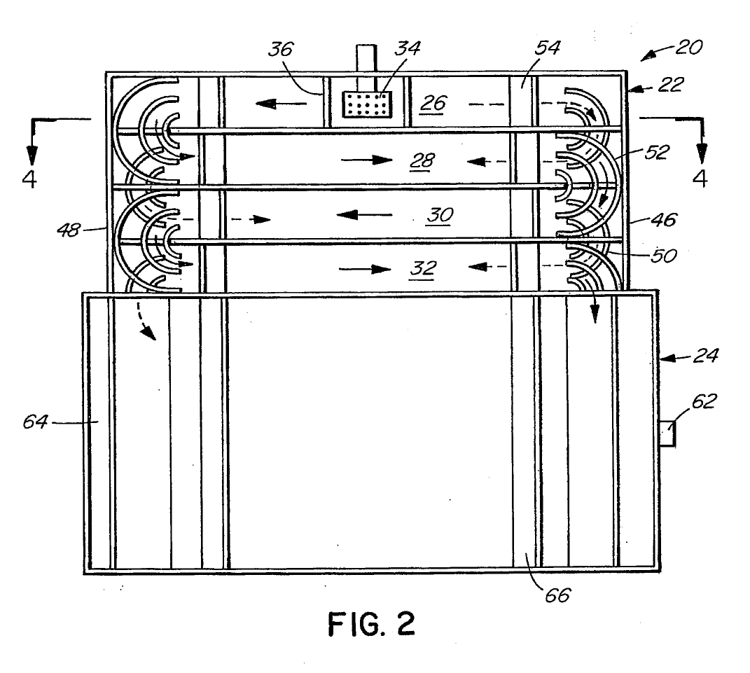

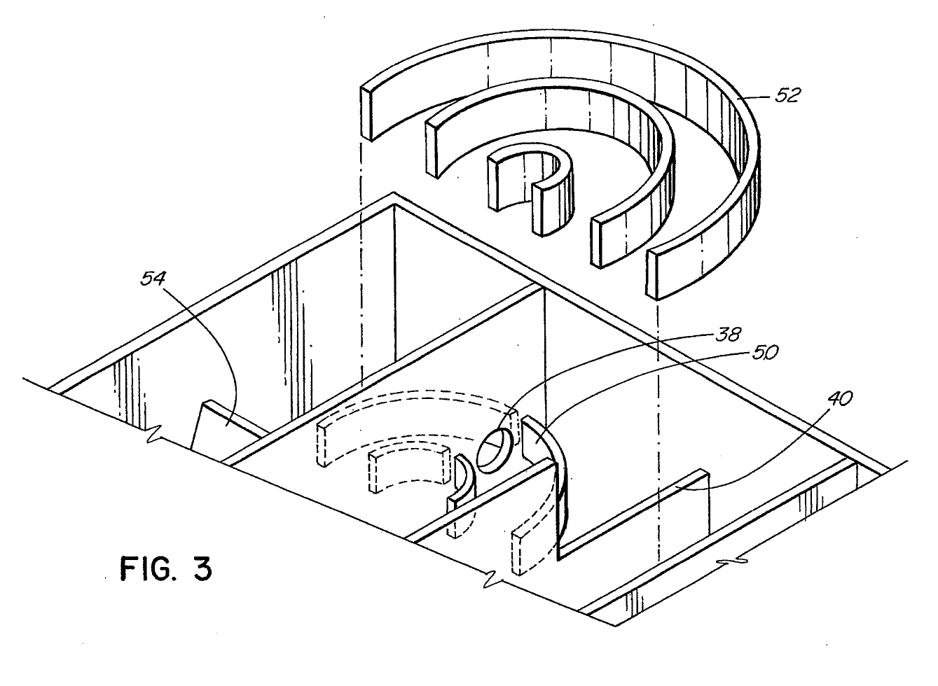

The settling system 20 will now be further described with specific reference to the Figures. Referring to FIGS. 1, 2 and 3, there is shown a perspective view of a settling system according to one embodiment, a top plan view of the settling system, and a perspective view of a portion of the settling system drawn to a larger scale, respectively. As indicated, the settling system 20 includes a pre-settler 22 of a plurality of channels arranged for flow of aqueous and organic phases generally counter-currently with respect to each other. In the present embodiment shown in FIGS. 1 and 2, the pre-settler 22 is a settling tank that includes four channels 26, 28, 30, 32 in parallel arrangement with respect to each other such that each channel 26, 28, 30, 32 shares a common wall with at least one adjacent channel 26, 28, 30, 32 and the fourth channel 32 shares a common wall with the main settler 24.

A launder or an inlet pipe 34 enters the first channel 26 and provides a fluid connection with the mixer for the introduction of an emulsion of the first and second phases from the mixer. According to the present embodiment, the inlet pipe 34 enters the first channel through a sidewall, proximal the center thereof. A pair of generally vertical baffles 36 extend in the flow path of the emulsion, with a respective one of the pair of baffles 36 on each side of the inlet pipe 34 for reducing turbulent flow and facilitating initial separation of the first and second phases.

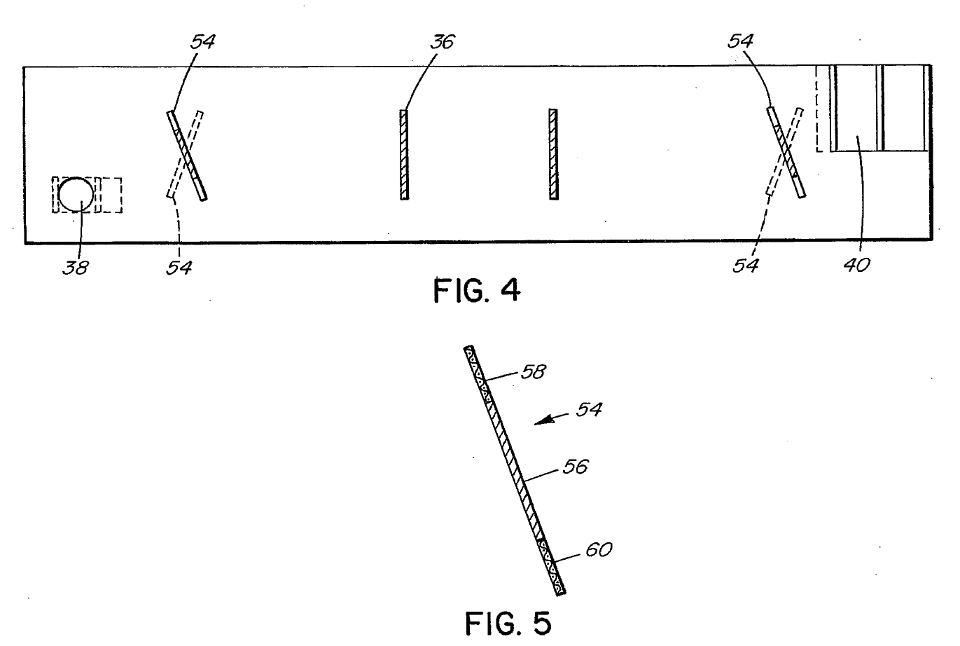

Each one of the channels 26, 28, 30, 32 includes an aqueous outlet 38 and an organic outlet 40 proximal respective ends thereof (also shown in FIG. 4) with the aqueous outlet 38 located lower in the channel than the organic outlet 40 for promoting counter-current flow of the aqueous and organic phases when in use. Each aqueous outlet 38 is an opening such as a hole or rectangular opening that extends through the lower portion of the sidewall of the respective channel 26, 28, 30, 32. The aqueous outlet 38 for the each of the first, second and third channels 26, 28, 20 extends through a respective sidewall into a respective adjacent, downstream one of the channels 28, 30, 32. Thus, the aqueous outlet 38 for the first channel 26 extends through a sidewall in the first channel 26, into the second channel 28. Similarly, the aqueous outlet 38 for the second channel 28 extends through a sidewall in the second channel 28, into the third channel 30. Likewise, the aqueous outlet 38 for the third channel 30 extends through a sidewall in the third channel 30, into the fourth channel. In the present embodiment, the pre-settler includes four channels 26, 28, 30, 32. Thus, the aqueous outlet 38 for the fourth channel 32 extends through the sidewall of the fourth channel 32 into the main settler 24. Each aqueous outlet 38 thereby provides an aqueous inlet in the respective subsequent, downstream channel or main settler 24.

The aqueous outlets 38 for the channels 26, 28, 30, 32 are located proximal alternating ends of the pre-settler 22 in successive channels such that the aqueous outlets 38 for the first and third channels 26, 30 are located proximal one end 46 of the pre-settler 22, while the aqueous outlets 38 for the second and fourth channels 28, 32 are located proximal the opposing end 48 of the pre-settler 22. Thus, the respective aqueous inlet and respective aqueous outlet are located near opposite ends in each of the second, third and fourth channels 28, 30, 32.

Each organic outlet 40 is a weir that provides an opening in the sidewall of the respective channel 26, 28, 30, 32 at the opposite end of the channel 26, 28, 30, 32 as the aqueous outlet 38. The organic outlet 40 for each of the first, second and third channels 26, 28, 30 is located at an upper portion of a respective sidewall for fluid flow into a respective adjacent, downstream, one of the channels 28, 30, 32. Again, the pre-settler includes four channels 26, 28, 30, 32. Thus, the organic outlet 40 for the fourth channel 32 is located in the sidewall of the fourth channel 32 for fluid flow into the adjacent main settler 24. Similarly, each organic outlet 40 thereby provides an organic inlet in the respective subsequent, downstream channel or main settler 24.

Like the aqueous outlets 38, the organic outlets 40 for the channels 26, 28, 30, 32 are located proximal alternating ends of the pre-settler 22 in successive channels such that the aqueous outlets 38 for the second and fourth channels 28, 32 are located proximal one end 46 of the pre-settler 22, while the aqueous outlets 38 for the first and third channels 26, 30 are located proximal the opposing end 48 of the pre-settler 22. Thus, the respective organic inlet 38 and respective organic outlet 40 are located near opposite ends in each of the second, third and fourth channels 28, 30, 32.

The respective aqueous outlet 38 and the respective organic outlet 40 are also located near opposite ends in each of the channels 26, 28, 30, 32, thereby promoting flow in a counter-current fashion.

Continued reference is made to FIGS. 1, 2 and 3. Aqueous baffles 50 are provided at each aqueous outlet 38 and organic baffles 52 are provided at each organic outlet 40 with the aqueous baffles 50 located lower in the pre-settler 22 than the organic baffles 52 such that the aqueous baffles 50 can be located under the organic baffles 52 in the pre-settler 22. The aqueous baffles 50 are curved in a semi-circular cross-section on each side of each aqueous outlet 38 of the first, second and third channels 26, 28, 30 (at each aqueous outlet 38 and aqueous inlet) and therefore extend into the respective subsequent channel 28, 30, 32 to promote laminar fluid flow through the aqueous outlets 38. The aqueous baffles 50 at the aqueous outlet 38 for the fourth channel 32, however, are disposed on the outlet side only, and therefore do not extend into the main settler 24.

The organic baffles 52 are curved in a semi-circular cross-section on each side of each organic outlet 40 of the first, second and third channels 26, 28, 30 (on each side of the weir) and therefore extend into the respective subsequent channel 28, 30, 32 to promote laminar fluid flow through the organic outlets 40. The organic baffles 52 at the organic outlet 40 for the fourth channel 32, however, are disposed in the fourth channel 32 only, and therefore do not extend into the main settler 24.

Referring now to FIGS. 1, 4 and 5, inclined baffles 54 extend across each of the channels 26, 28, 30, 32, in the flow path of the emulsion. FIG. 4 is a section taken along the line 4-4 of FIG. 2 and shows the inclined baffles 54 of the first channel 26 along with hidden detail including inclined baffles 54 of the second channel 28. In each one of the channels 26, 28, 30, 32, one of the inclined baffles 54 is located proximal one end 46 of the pre-settler and a second one of the inclined baffles 54 is located proximal the opposing end 48 of the pre-settler. Thus, in each one of the channels, 26, 28, 30, 32, one of the baffles 54 is located proximal the aqueous outlet 38 and the other of the baffles 54 is located proximal the organic outlet 40. Each inclined baffle 54 is arranged at an angle offset from the vertical for promoting separation of the first phase from the second phase. The angle can be any suitable angle, for example, up to 45 degrees offset from the vertical. Although the angle can be any suitable angle, in the present embodiment, each inclined baffle 54 is arranged at an angle of about 20 degrees from the vertical, with a top edge of the inclined baffle 54 displaced longitudinally from the bottom edge of the inclined baffle 54 such that the top edge is spaced a greater longitudinal distance from the organic outlet 40 than the bottom edge.

Each inclined baffle 54 includes an impervious, or solid, central portion 56, a pervious upper portion 58 and a pervious lower portion 60, as best shown in FIG. 5. The impervious central portion 56 can be any suitable solid material and the pervious upper and lower portions 58, 60 can be made of any suitable screen materials. For example, the lower portion can be made of a suitable hydrophilic material for aiding in removal of organic droplets from the passing aqueous phase. The upper portion can be made of, for example, a suitable hydrophobic material to aid in removal of aqueous droplets from the passing organic phase. Each inclined baffle 54 is designed and spaced from the bottom of the respective channel to permit free fluid flow without short-circuiting. Similarly, each inclined baffle 54 is designed and spaced from the top of the respective channel and from the top of the fluid level to permit free fluid flow without short-circuiting. In the present description, short-circuiting refers to insufficient retention time of the solution in the settlers and channels.

Referring again to FIGS. 1 and 2, the main settler 24 includes an aqueous outlet 62 at one end thereof, opposite to the end of the main settler 24 at which the aqueous inlet is provided by the aqueous outlet 38 of the fourth channel 32. The aqueous outlet 62 can be any suitable outlet such as a conventional underflow/adjustable overflow weir level. An organic outlet 64 is provided at the opposite end of the main settler 24 and can be any suitable outlet such as a conventional overflow weir to an organic trough as shown in FIG. 1.

Inclined baffles 66 also extend across the entire width of the main settler 24, in the flow path of the partially separated phases. Each inclined baffle 66 in the main settler 24 is located proximal a respective end 46 of the main settler 24. Thus, an inclined baffle 66 is located proximal the aqueous outlet 62 of the main settler 24 and another inclined baffle 66 is located proximal the organic outlet 64 of the main settler 24. Each inclined baffle 66 in the main settler 24 is arranged at an angle offset from the vertical for promoting separation of the first phase from the second phase. The angle can be any suitable angle such as, for example, up to 45 degrees offset from the vertical. Although the angle can be any suitable angle, in the present embodiment, each inclined baffle 66 in the main settler 24 is arranged at an angle of about 20 degrees from the vertical, with a top edge of the inclined baffle 66 displaced longitudinally from the bottom edge of the inclined baffle 66 such that the top edge is spaced a greater longitudinal distance from the organic outlet 64 than the bottom edge.

As with the inclined baffles 54 in the channels, each inclined baffle 66 in the main settler 24 includes an impervious, or solid, central portion and pervious upper and lower portions. The inclined baffles 66 are spaced from the bottom of the main settler 24 to permit free flow of fluid under the inclined baffle 54. Similarly, each inclined baffle 66 is spaced from the top of the main settler 24 and from the top of the fluid level to permit free flow of fluid above the inclined baffle 66.

In use, the emulsion of first and second phases from the mixer is centrally introduced to the first channel 26 via the inlet pipe 34. During flow, separation of the first and second phases is initiated in the first channel 26 as the organic and aqueous phases begin forming layers and the initially separated phases flow in opposite directions in the first channel 26 as the top, primarily organic phase flows toward the organic outlet 40 and the bottom, primarily aqueous phase flows toward the aqueous outlet 38. The direction of flow of the organic phase switches in each subsequent channel, thereby alternating flow directions in each subsequent channel. Similarly, the direction of flow of the aqueous phase switches in each subsequent channel, thereby alternating flow directions in each subsequent channel. Thus, the phases flow in counter-current fashion in each of the channels 26, 28, 30, 32.

Phase separation is incrementally improved in each subsequent channel 28, 30, 32 as the phases further separate during flow through each channel. The aqueous and organic baffles 50, 52 aid in promoting laminar flow, reducing turbulence to maintain separation of the phases as the bottom, primarily aqueous phase flows through each aqueous outlet 38 and the top, primarily organic phase flows through each organic outlet 40.

The inclined baffles 54 in the channels 26, 28, 30, 32 further aid in promoting separation of the phases as the phases in the pre-settler 22 flow up against the inclined baffles 54 urging droplets of the organic phase in the aqueous flow upwardly and droplets of the aqueous phase in the organic flow downwardly.

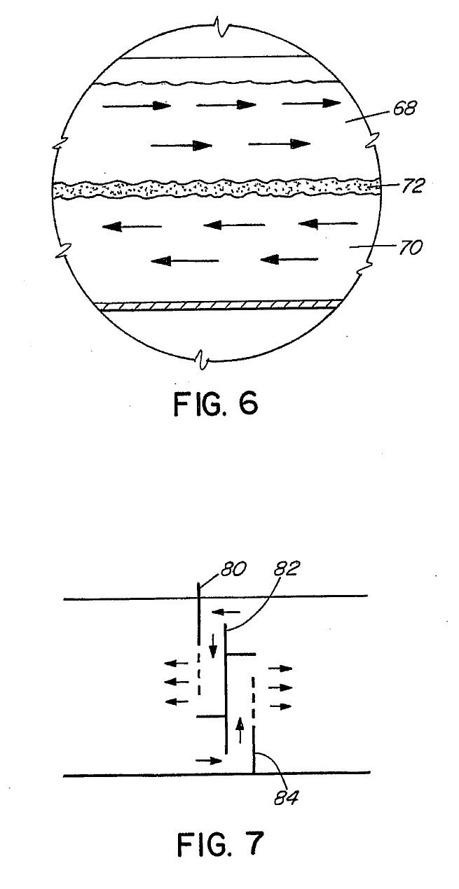

The aqueous phase with some remaining emulsion exits from the aqueous outlet 38 in the fourth channel 26 and into the main settler 24. Similarly, the organic phase with some remaining emulsion exits from the organic outlet 40 in the fourth channel 26 and into the main settler 24. Again, the organic phase 68 and the aqueous phase 70 are layered with the emulsion 72 at the organic/aqueous interface. The organic and aqueous phases 68, 70, respectively, flow in counter-current fashion toward the respective one of the aqueous outlet 62 and organic outlet 64 at opposing ends of the main settler 24, as best shown in FIG. 6. The inclined baffles 66 in the main settler 24 further aid in promoting separation of the phases as the phases in the main settler 24 flow up against the inclined baffles 66 urging droplets of the organic phase in the aqueous flow upwardly and droplets of the aqueous phase in the organic flow downwardly.

In operation of the above-described settling system, the crud-like material tends toward the interface between the organic and aqueous phases during counter-current flow of the phases through the channels of the pre-settler 22 and the main settler 24. Control of the interfacial crud layer can be effected in any suitable manner, such as by suction of some of the material using a suction pump and pipe (not shown) at the interfacial level in a semi-continuous or continuous operation. The crud can then be separated from any organic and aqueous phases suctioned off and the organic and aqueous phases returned to the pre-settler 22. The crud-like material is inhibited from rising and floating over the weir (organic outlet 64) in the main settler 24 and is inhibited from passing to the aqueous phase when the interfacial crud layer is controlled to an acceptable level. When controlled, the crud layer acts as a filter between the organic and aqueous phases.

In alternative embodiments of the present invention, the pre-settler may include other numbers of channels, rather than four channels as in the above-described embodiment. Further, the pre-settler and the main settler may include any number of inclined baffles or, alternatively, may be without inclined baffles. In a particular alternative embodiment, the baffles are vertical rather than inclined. One such alternative baffle arrangement is shown in the side view of FIG. 7 which shows three baffles 80, 82, 84 in an exemplary channel. The three baffles 80, 82, 84 provide an indirect flow path for travel of the aqueous phase and for travel of the organic phase, while inhibiting short-circuiting (insufficient retention time of the solution in the settlers and channels).

In other embodiments, the baffles can be any other suitable angle offset from the vertical. The baffles can extend through the entire channel such that the bottom portion of the baffles extends to the bottom of the respective settler. With the baffles spaced from the bottom of the settler and from the top of the organic phase, the baffles can also be impervious. In other alternative embodiments, the pre-settler may be without curved baffles at the aqueous outlets or at the organic outlets. In still other embodiments, the mixer may be in direct connection with the first channel of the pre-settler, for example, so that the mixed phases enter the pre-settler directly, rather than entering through the pipe as described. In yet further embodiments, the main settler can be arranged for co-current flow, rather than counter-current flow of phases.

The present invention provides advantages over prior art co-current settlers in which the crud tends to float to the organic surface and overflow with the organic to the next stage. In such prior art systems, the crud is thereby beaten to a finer material causing a tighter emulsion that does not permit separation in the time during flow through a pre-settler and main settler which results in poor separation and can cause complications such as flooding in which the aqueous phase is carried over the organic outlet weir in large volumes and the organic phase is carried out the aqueous outlet in large volumes.

It will be appreciated that emulsions with high organic to aqueous ratio rise to the top while emulsions with low organic ratio descend in the settler. Emulsions with organic to aqueous ratio nearing 1:1, in which coalescence is minor or negligible, stay in the central zone, between the top and the bottom. In the embodiments described herein, emulsions with high organic to aqueous ratio and low organic to aqueous ratio are transferred from one channel into the next (or into the main settler) in preference to emulsions that have an organic to aqueous ratio nearing 1:1. Thus, emulsions that have an organic to aqueous ratio nearing 1:1 generally stay longer in the channels until coalescence advances. Therefore, stable emulsions have an extended retention time in each channel and in the main settler, aiding in reducing entrainments in phases leaving the settler. Further, control of the interfacial crud layer can be effected in any suitable manner, such as by suction of some of the material using a suction pump and pipe at the interfacial level in a semi-continuous or continuous operation, as described above.

The use of channels in a pre-settler in which the phases flow in a counter-current fashion facilitates the separation of phases and permits increased flow rates, thus increasing throughput of the settling system by comparison to a system employing a pre-settler absent such channels. Thus, increased throughput can be realized in a settling system having an equivalent footprint (or surface area). Alternatively, a similar throughput can be realized in a settling system having a smaller footprint. The addition of inclined baffles further promotes separation of phases permitting a further increase in throughput. It will be appreciated that the capital investment for such a settling system can be reduced with a reduced footprint as the smaller settler system is less costly to manufacture. Using the baffles as described, a much cleaner aqueous phase exits the system.

While the embodiments described herein are directed to particular implementations of the invention, it will be understood that modifications and variations to these embodiments are within the scope and sphere of the present application. For example, the size and shape of many of the features may vary while still performing the same function. Further, the particular arrangement of certain features can vary. For example, the depth of the channels may differ from the depth of the main settler. Many other alterations, modifications and variations can be effected. Those of skill in the art can effect such alterations, modifications and variations to the particular embodiments without departing from the scope of the present application, which is defined by the claims appended hereto.

What is claimed is:

1. A method of solvent extraction for extracting a component dissolved or dispersed in a first phase, into a second phase, the method comprising:
mixing the first phase with the second phase, the second phase being insoluble or immiscible with the first phase and having a greater chemical affinity for the component for extracting the component from the first phase; and
subjecting the mixed first and second phases to settling for separating the first and second phases, the settling comprising a pre-settling stage in which there is an initial separation of the first and second phases, and a subsequent main settling stage for further separating the first and second phases, the pre-settling stage comprising a plurality of channels in which the first and second phases are caused to flow generally counter-currently with respect to each other.

2. The method according to claim 1, wherein the first and second phases are caused to flow generally counter-currently with respect to each other in each of the plurality of channels.

3. The method according to claim 1, wherein the mixed first and second phases are introduced to a first one of said plurality of channels and are caused to flow generally counter-currently in said first one of said plurality of channels.

4. The method according to claim 4, wherein said first and second phases are introduced at opposing ends of each subsequent one of said channels for further separating said first and second phases.

5. The method according to claim 4, wherein said first and second phases are introduced to each subsequent one of said channels by flowing around curved baffles at inlets of the channels for promoting laminar flow.

6. The method according to claim 5, wherein said first and second phases are expelled from each of said channels by flowing around curved baffles at outlets of said channels for promoting laminar flow.

7. The method according to claim 1, wherein said main settling stage is effected in a main settling chamber in which the initially separated first and second phases are caused to flow generally counter-currently with respect to each other.

8. The method according to claim 7, wherein the initially separated first and second phases are introduced at opposing ends of the main settling chamber.

9. The method according to claim 1, wherein the first and second phases are caused to flow counter-currently with respect to each other, past baffles inclined at an angle to the vertical in ones of the channels of the pre-settling stage for promoting separation.

10. The method according to claim 9, wherein the first and second phases are caused to flow counter-currently with respect to each other, past baffles inclined at an angle to the vertical in the main settling chamber for further promoting separation.

11. A settling system for use in solvent extraction separation of a first phase from a second phase after mixing, the second phase having a greater chemical affinity for a component dissolved or dispersed in the first phase for extracting the component from the first phase, the system comprising:
a pre-settler comprising a plurality of channels arranged for flow of said first and second phases generally counter-currently with respect to each other for initial separation of said first and second phases; and
a main settler for further separating the first and second phases.

12. The settling system according to claim 11, wherein each of said channels is fluidly connected proximal opposing ends thereof to one of an adjacent downstream one of the channels and the main settler.

13. The settling system according to claim 11, wherein each one of said channels includes outlets at opposing ends thereof, the outlets at opposing ends being located at different heights in the respective channel for promoting counter-current flow of said first and second phases.

14. The settling system according to claim 13, wherein each of said channels includes curved baffles at each of said outlets for promoting laminar flow.

15. The settling system according to claim 13, wherein a first one of said channels includes an inlet for receiving the first and second phases after mixing.

16. The settling system according to claim 15, wherein each subsequent one of said channels includes a pair of inlets at opposing ends thereof, the inlets corresponding to the outlets of a previous one of said channels.

17. The settling system according to claim 15, wherein each said subsequent one of said channels includes curved baffles at each of said inlets for promoting laminar flow.

18. The settling system according to claim 11, wherein said main settler includes a pair of inlets, a respective one of the inlets being located at opposite ends of said main settler for promoting counter-current flow in said main settler.

19. The settling system according to claim 11, wherein the pre-settler comprises baffles extending across at least one of the channels.

20. The settling system according to claim 11, wherein the pre-settler comprises respective baffles extending across ones of said channels.

21. The settling system according to claim 20, wherein said baffles are generally planar.

22. The settling system according to claim 21, wherein said baffles are disposed at an angle with respect to the vertical.

23. The settling system according to claim 22, wherein said baffles are disposed at an angle of up to 45 degrees offset from the vertical.

24. The settling system according to claim 22, wherein said baffles are disposed at an angle of about 20 degrees with respect to the vertical.

25. The settling system according to claim 22, wherein said baffles comprise an impervious central portion.

26. The settling system according to claim 25, wherein said baffles comprise a pervious upper portion and a pervious lower portion.

27. The settling system according to claim 11, wherein said main settler comprises baffles extending across the width thereof.

28. The settling system according to claim 27, wherein the baffles in the main settler are disposed at an angle with respect to the vertical.

29. The settling system according to claim 28, wherein the baffles in the main settler are disposed at an angle of up to 45 degrees with respect to the vertical.

30. The settling system according to claim 28, wherein the baffles in the main settler are disposed at an angle of about 20 degrees with respect to the vertical.

31. A settling system for use in separating a first phase from a second phase after mixing in a solvent extraction process, the second phase having a greater chemical affinity for a component for extracting the component from the first phase, the system comprising a settling tank having a respective outlet at each end thereof for promoting counter-current flow of the first and second phases with respect to each other, the settling tank having at least one baffle arranged at an angle offset from the vertical for promoting separation of the first phase from the second phase.

32. The settling system according to claim 31 wherein said settling tank comprises a pair of baffles arranged at an angle offset from the vertical for promoting separation of the first phase from the second phase.

33. The settling system according to claim 31 wherein said settling tank comprises one of a plurality of channels in a pre-settler.

34. The settling system according to claim 33, wherein each one of said plurality of channels has at least one baffle arranged at an angle offset from the vertical for promoting separation of the first phase from the second phase.

35. The settling system according to claim 33, wherein each one of said plurality of channels has a plurality of baffles arranged at an angle offset from the vertical for promoting separation of the first phase from the second phase.

36. The settling system according to claim 33, wherein said settling system further comprises a main settler for further separating said first and second phases.

37. The settling system according to claim 36, wherein said main settler has at least one baffle arranged at an angle offset from the vertical for promoting separation of the first phase from the second phase.

38. The settling system according to claim 31, wherein said baffle is disposed at an angle of up to 45 degrees with respect to the vertical

39. The settling system according to claim 31, wherein said baffle is disposed at an angle of about 20 degrees with respect to the vertical.

40. The settling system according to claim 31, wherein said baffle comprises an impervious central portion.

41. The settling system according to claim 31, wherein said baffle comprises a pervious upper portion and a pervious lower portion.

42. The settling system according to claim 41, wherein said upper portion comprises a hydrophobic material and said lower portion comprises a hydrophilic material.
